(19) United States
(12) Patent Application Publication
(10) Pub. No.: US 2010/0013818 A1
(43) Pub. Date: Jan. 21, 2010

(54) ELECTRONIC PAPER DISPLAY, SEMICONDUCTOR INTEGRATED CIRCUIT AND OPERATING METHOD FOR SEMICONDUCTOR INTEGRATED CIRCUIT

(75) Inventors: Akihito AKAI, Yokohama (JP); Hiroyuki NITTA, Fujisawa (JP)

Correspondence Address: MATTINGLY & MALUR, P.C., 1800 DIAGONAL ROAD, SUITE 370, ALEXANDRIA, VA, 22314, US

(73) Assignee: RENESAS TECHNOLOGY CORP., Tokyo (JP)

(21) Appl. No.: 12/470,672

(22) Filed: May 22, 2009

(30) Foreign Application Priority Data
Jul. 16, 2008 (JP) 2008-184385

(51) Int. Cl. G06F 3/038

(52) U.S. Cl. 345/212; 345/213

(57) ABSTRACT

The present invention is directed to reduce power consumption in a standby operation period as a period of holding display in a no-power state. An electronic paper display has an electronic paper display panel, a display driver/controller, a battery, and a booster power source circuit. The display panel can display data by writing display data and, after that, can hold the display in a no-power state. The booster power source circuit generates a boosted power source voltage by an operation of boosting power source voltage from the battery, and the display driver/controller executes the writing of the displayed data to the display panel by using the boosted power source voltage. In the following standby operation period in which the display panel holds the display in the no-power state, the boosting operation of the booster power source circuit is stopped.

### CLAIM OF PRIORITY

The present application claims priority from Japanese application JP 2008-184385 filed on Jul. 16, 2008, the content of which is hereby incorporated by reference into this application.

### BACKGROUND OF THE INVENTION

The present invention relates to an electronic paper display, a semiconductor integrated circuit for use in the same, and an operation method for the semiconductor integrated circuit. More particularly, the invention relates to a technique useful to reduce power consumption in a standby operation period as a period of holding display in a no-power state.

Non-patent document 1 describes a 3.8-inch QVGA (320×240 pixels) color electronic paper capable of maintaining display even when the power source is turned off, having high reflectance of 30%, capable of performing light color display of 4,096 colors, and having a small thickness of 0.8 mm. Since no power is necessary to maintain display and rewriting is performed with low power consumption, the color electronic paper can be variously applied as novel electronic media which can be handled like paper for information display, product advertisement, and the like in public places.

A color electronic paper using a cholesteric liquid crystal has a structure of display parts of blue (B), green (G), and red (R) are stacked in order on a display face, and a light absorption layer is disposed on the back face of a substrate under the R display part. The cholesteric liquid crystal used in each of the display parts of B, G, and R is a liquid crystal composition obtained by a relatively large amount of a chiral additive (chiral material) to a nematic liquid crystal at a content percentage of tens weight %. By making a relatively large amount of the chiral material contained in the nematic liquid crystal, a cholesteric phase in which the nematic liquid crystal molecules are strongly twisted spirally can be formed.

A cholesteric liquid crystal has bistability (memory performance) and can be set in a planar state of reflecting light having a specific wavelength, a focal conic state of passing light, and an intermediate state by adjustment of the intensity of an electric field applied to the liquid crystal. Once the cholesteric liquid crystal enters the planar state, the focal conic state, or the intermediate state, the state can be stably maintained in a no-voltage-application state.

Non-patent document 2 describes that a cholesteric liquid crystal obtains polymer stabilization or electric bistability by adding a small amount of polymer. In a state where no electric field is applied, the cholesteric liquid crystal is in a planar orientation and selectively reflects color light according to the spiral pitch of the liquid crystal. When a weak electric field is applied, the cholesteric liquid crystal changes in a focal conic orientation and passes light. When the electric field is stopped in this state, the focal conic orientation is maintained. The document also describes that, by supplying application voltage having a peak-to-peak value from about 50 volts to about 300 volts to a dual charge generation layer for AC driving in a plastic substrate, the reflectance of the cholesteric liquid crystal changes from about 1.0 to about 0.1 or less.

Further, non-patent document 3 describes an optical-write-type electronic paper having contrast ratio improved by employing a perpendicular orientation liquid crystal microcapsule technique. The optical-write-type electronic paper has a structure in which a cholesteric liquid crystal microcapsule layer and an organic photoconductor layer are sandwiched between a pair of film substrates on which a transparent electrode is disposed. The cholesteric liquid crystal can easily produce three primary colors (red, green, and blue) by adjusting the material composition. By stacking optical-write-type electronic papers of three primary colors, color display can be performed.

Patent document 1 describes a self-write-type electronic paper having a display unit for displaying and recording a document image in a no-power state and a processing unit for executing a process on electronic data. The processing unit includes a driver for driving the display unit, a radio unit for performing radio data communication with an external device, a memory for holding electronic data, a CPU, an operation unit, and a battery.

[Non-patent document 1] Toshiaki Yoshihara, et al., “Color Electronic Paper”, Fujitsu, 57, 3, pp. 302 to 306, May, 2006
[Non-patent document 2] Hiroshi Arisawa et al., “Color Electronic Paper using Cholesteric Liquid Crystal, Writing of Optical Image by Organic Photoconductors”, The Institute of Image Electronics Engineers of Japan, Japan Hardcopy 2000, collection of papers, pp. 89 to 92
[Non-patent document 3] Naoki Hiji et al., “Monochromatic Optical-Write-Type Electronic Paper, Liquid Crystal Microcapsule Technique and Application System”, Fujixerox Technical Report No. 15, 2005, pp. 56 to 63
[Patent document 1] Japanese Unexamined Patent Publication No. 2005-267173

### SUMMARY OF THE INVENTION

As described in the beginning, in recent years, attention is paid to an electronic paper display realizing flexibility, thinness and lightness, and visibility like paper. Application of the electronic paper display to an electronic book, an electronic tag, and an electronic poster is being embodied. In particular, the electronic paper display does not need a backlight and has a display holding characteristic by itself. Consequently, the electronic paper display has an advantage that refreshing operation is unnecessary after determination of display, and power consumption can be reduced by that amount. Because of the characteristic, there are some fields to which the electronic paper display is applied more suitably than a liquid crystal display or an organic EL display employed in a mobile device such as a cellular phone or a music player. For example, display data in the electronic tag is basically a still image and it can be predicted that the rewriting frequency is as low as a few times per day. Consequently, the electronic tag is one of applications capable utilizing effectiveness of the electronic paper display.

On the other hand, in the case of assuming an application of an electronic tag, for example, an electronic price tag, a price tag has to be set for each commodity, so that the number of modules of the electronic price tags is large. Under the situation, it is unrealistic to execute control of displaying electronic price tags and power supply by wire from the viewpoint of flexibility of setting modules of the electronic price tags. It is expected that data transfer by radio is common for the display control, and mounting of a button battery, a coin battery, or the like is common for the power supply. However, the current capacity of each of the button battery and the coin battery is small. To realize long-time use of an electronic price tag module, lower power consumption of the electronic paper module is necessary. In an application using low power consumption as a characteristic of the electronic paper display, for example, in an electronic tag, it is important that the electronic tag module can be used for long time.

On the other hand, prior to the present invention, the inventors of the present invention have studied and developed a driver/controller LSI for controlling display of an electronic paper used for an electronic tag. In the study and development, the inventors of the present invention clarified a problem such that drive voltage applied to an electronic paper display for writing display data is relatively high as 30 to 80 volts as described in the non-patent document 2.

Therefore, a boosted power source voltage obtained by boosting the battery voltage of, for example, about two volts of a button battery, a coin battery, or the like mounted on an electronic tag module by about 20 times can be generated by using a booster power source voltage circuit. At the time of writing display data of a display panel of an electronic paper display, the boosted power source voltage of about 20 times is used. On the other hand, the inventors of the present invention also studied and clarified a problem such that, because of a characteristic of an electronic paper display having a display holding characteristic in a no-power state without requiring refreshing operation after determination of display of the display panel, when the boosting operation of the booster power source voltage circuit is continued, unnecessary power is consumed, and the battery having the small current capacity exhausts early. By examination of the inventors of the present invention, it is also clarified that the cause of the waste power consumption due to the continuation of the boosting operation of the booster power source voltage circuit is energy consumption at the time of charging/discharging of a number of capacitors of a number of charge pump circuits configuring the booster power source voltage circuit.

Therefore, an object of the present invention is to provide an electronic paper display with reduced power consumption in a standby operation period as a period of holding display in a no-power state.

In an embodiment of the present invention, to achieve the object, the boosting operation of the booster power source voltage circuit is stopped in the standby operation period as the period of holding display in the no-power state.

By the stop of the boosting operation in the standby operation period, after lapse of long time, residual charges of the electronic paper display disappear. After that, a request for updating display data of the display panel of the electronic paper display and update display data are transferred almost at the same time from an external device as a host device. In response to the update request, the boosting operation of the booster power source voltage circuit starts. However, since the number of booster stages of the booster power source voltage circuit is considerably large, the boosting operation delay time after the booster power source voltage circuit starts the boosting operation until the boosted power source voltage reaches a predetermined level is long. However, the update display data transferred from the host device during the period disappears, so that update display data has to be re-transferred by the host device. This problem is also clarified by the examination of the inventors of the present invention.

Therefore, another object of the present invention is to make re-transfer of the display data unnecessary, which is from the host device after completion of the boosting operation after start of the boosting operation of the booster power source voltage circuit in response to the request for updating display data from the host device.

Further, by the examination of the inventors of the present invention, it was also clarified that, only by stopping the boosting operation of the booster power source voltage circuit in the standby operation period, residual charges of high voltage remain for a long period in the electronic paper display, and there is a risk that display in the display panel of the electronic paper display is undesirably influenced by the residual charges.

Therefore, further another object of the present invention is to lessen the undesirable influence on the display of the display panel in the electronic paper display caused by the residual charges in the standby operation period.

The above and other objects of the present invention and novel features will become apparent from the description of the specification and the appended drawings.

Typical ones of inventions disclosed in the application will be briefly described as follows.

A typical electronic paper display of the present invention has an electronic paper display panel (101), a display driver/controller (102), a battery (Bat), and a booster power source circuit (106).

The electronic paper display panel (101) can display data by writing display data and, after that, can hold the display even in a no-power state (refer to FIG. 1).

The booster power source circuit (106) generates a boosted power source voltage (Vdd) by an operation of boosting power source voltage (Vpower) supplied from the battery (Bat) (refer to a period from T₁ to T₂ and a period from T₂ to T₃ in FIG. 2B), and the display driver/controller (102) executes the writing of the displayed data to the electronic paper display panel (101) by using the boosted power source voltage (Vdd) (refer to FIG. 1 and the period from T₂ to T₃ in FIG. 2B).

In a standby operation period in which the electronic paper display panel (101) holds the display in the no-power state after the writing of the display data, the boosting operation of the booster power source circuit (106) is stopped (refer to FIG. 1 and a period from T₃ to T₄ in FIG. 2B).

An effect obtained by a typical one of inventions disclosed in the application will be briefly described as follows. An electronic paper display with reduced power consumption in a standby operation period as a period of holding display in a no-power state can be provided.

### BRIEF DESCRIPTION OF THE DRAWINGS

FIG. 1 is a diagram showing the configuration of an electronic paper display used for an electronic tag in an embodiment of the present invention.

FIGS. 2A and 2B are diagrams illustrating the configuration and operation of a booster power source circuit for supplying boosted power source voltage to an electronic paper display driver/controller LSI in the embodiment of the invention shown in FIG. 1.

FIGS. 3A and 3B are diagrams illustrating operation of writing update display data of an electronic paper display panel by a source signal line drive circuit and a gate scan line drive circuit of the electronic paper display driver/controller LSI in the embodiment of the present invention shown in FIG. 1.

FIG. 4 is a diagram showing the configuration of an electronic paper display driver/controller LSI as another embodiment of the present invention.

FIG. 5 is a diagram showing the configuration of an electronic paper display driver/controller LSI as further another embodiment of the present invention.

FIGS. 6A, 6B, and 6C are diagrams showing the configuration of a booster power source circuit provided in the electronic paper display driver/controller LSI illustrated in FIG. 5.

FIG. 7 is a diagram illustrating boosted voltage generating operation executed by a booster power source voltage generating circuit shown in FIG. 6B.

FIG. 8 is a diagram illustrating boosted voltage generating operation executed by a booster power source voltage generating circuit shown in FIG. 6C.

### DETAILED DESCRIPTION OF THE PREFERRED EMBODIMENTS

### Typical Embodiment

First, outline of a typical embodiment of the invention disclosed in the application will be described. Components indicated by reference numerals in the drawings referred to in parentheses in the description of the outline of the typical embodiment are included in the concept of the components.

[1] An electronic paper display as a typical embodiment of the present invention has an electronic paper display panel (101), a display driver/controller (102), a battery (Bat), and a booster power source circuit (106).

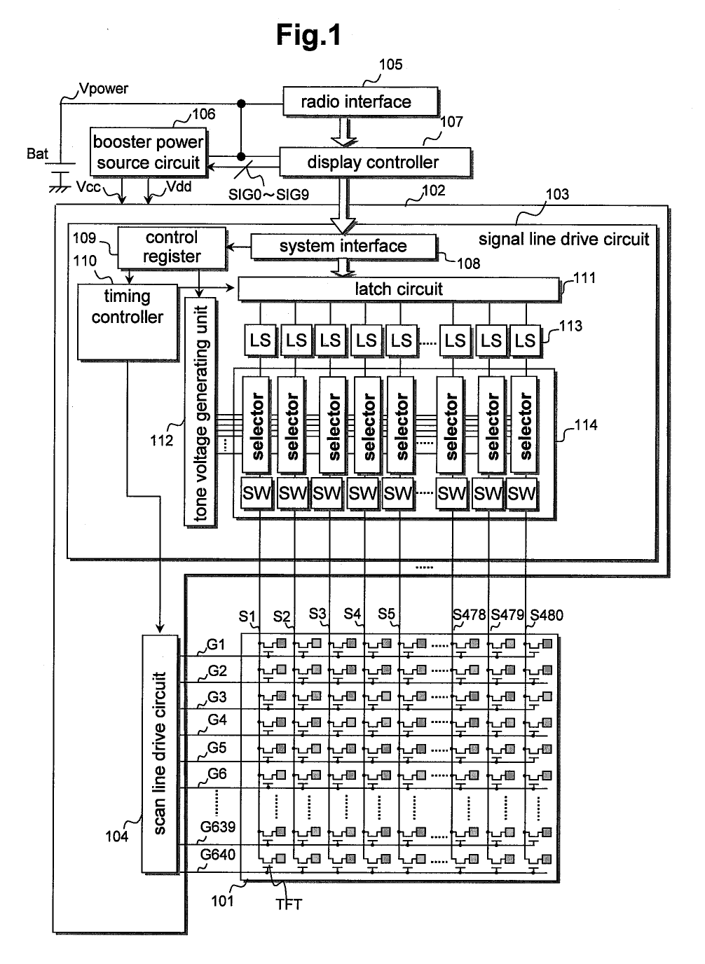

The electronic paper display panel (101) can display data by writing display data and, after the writing, can hold the display even in a no-power state (refer to FIG. 1).

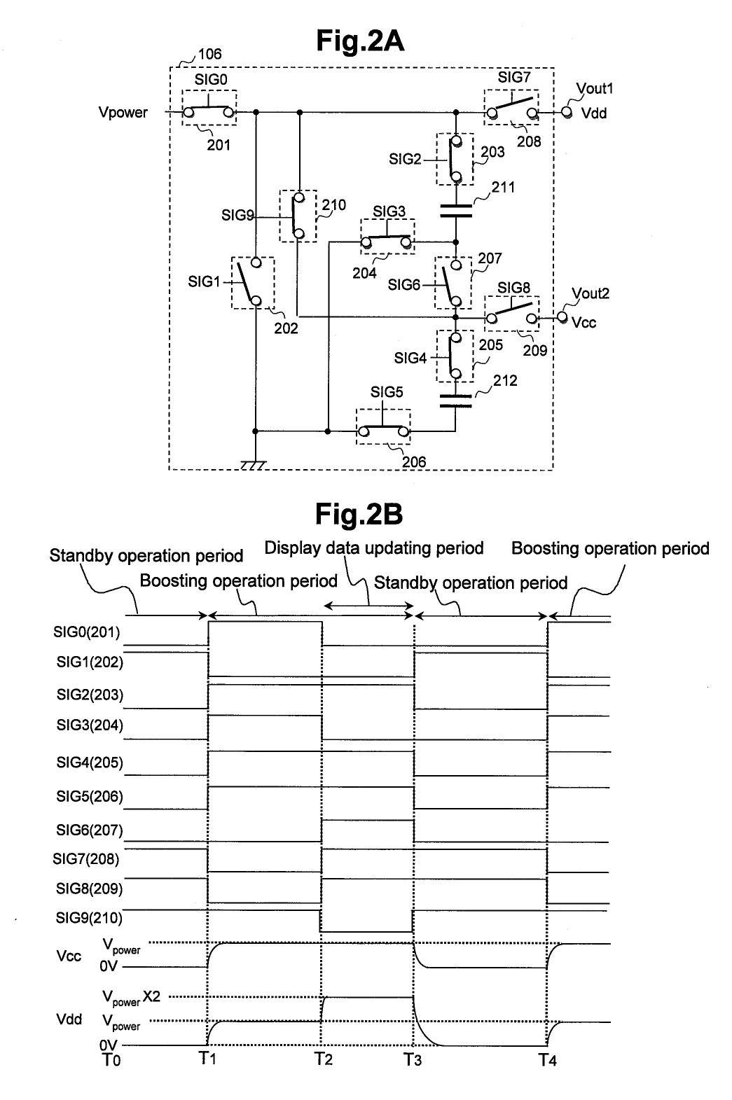

The booster power source circuit (106) generates a boosted power source voltage (Vdd) by an operation of boosting power source voltage (Vpower) supplied from the battery (Bat) (refer to a period from T₁ to T₂ and a period from T₂ to T₃ in FIG. 2B).

The display driver/controller (102) executes the writing of the displayed data to the electronic paper display panel (101) by using the boosted power source voltage (Vdd) supplied from the booster power source circuit (106) (refer to FIG. 1 and the period from T₂ to T₃ in FIG. 2B).

In a standby operation period in which the electronic paper display panel (101) holds the display in the no-power state after the writing of the display data to the electronic paper display panel (101) performed by the display driver/controller (102), the boosting operation of the booster power source circuit (106) is stopped (refer to FIG. 1 and a period from T₃ to T₄ in FIG. 2B).

In the embodiment, the boosting operation of the booster power source circuit is stopped in a standby operation period in which the electronic paper display panel holds the display in the no-power state after the writing of the display data, so that power consumption in the standby operation period as a period of holding display in the no-power state can be reduced.

In a preferred embodiment, the booster power source circuit (106) is characterized by being comprised of charge pump circuits in a plurality of stages including a plurality of switches (201 to 210) and a plurality of capacitors (211 and 212) (refer to FIG. 2A).

The electronic paper display as a more preferred embodiment further includes a latch circuit (111), wherein the latch circuit stores digital display data supplied from the host device after the boosting operation of the booster power source circuit (106) starts in response to a request of the writing of the display data to the electronic paper display panel (101) from a host device and the boosted power source voltage (Vdd) reaches a predetermined level at which the writing can be performed (refer to FIG. 1).

In the more preferred embodiment, after the boosted power source voltage (Vdd) reaches a predetermined level at which the writing can be performed, the latch circuit (111) stores the digital display data supplied from the host device. Therefore, the number of unnecessary transfer times of the digital display data from the host device can be reduced.

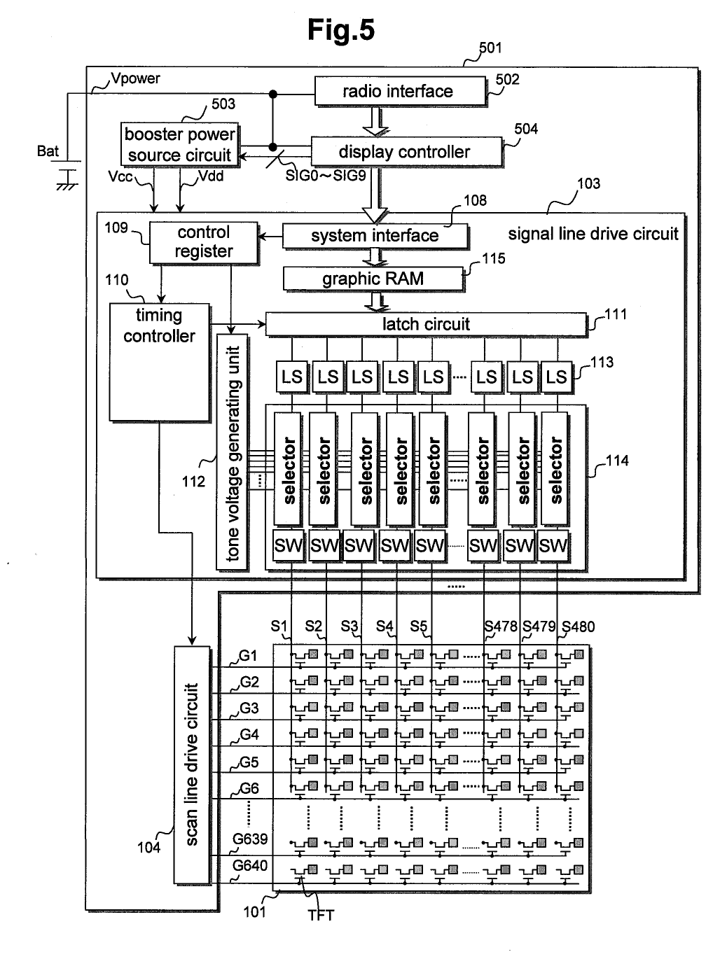

The electronic paper display as the more preferred embodiment further includes a built-in memory (115) for temporarily storing the digital display data supplied from the host device before the digital display data is stored in the latch circuit (111) (refer to FIG. 5).

In the more preferred embodiment, even when a request for updating display data of the display panel and update display data are transferred almost the same time from the host device, extinction of update display data during boosting operation delay time can be avoided by temporal storage in the built-in memory (115). Consequently, re-transfer of the update display data by the host device can be made unnecessary.

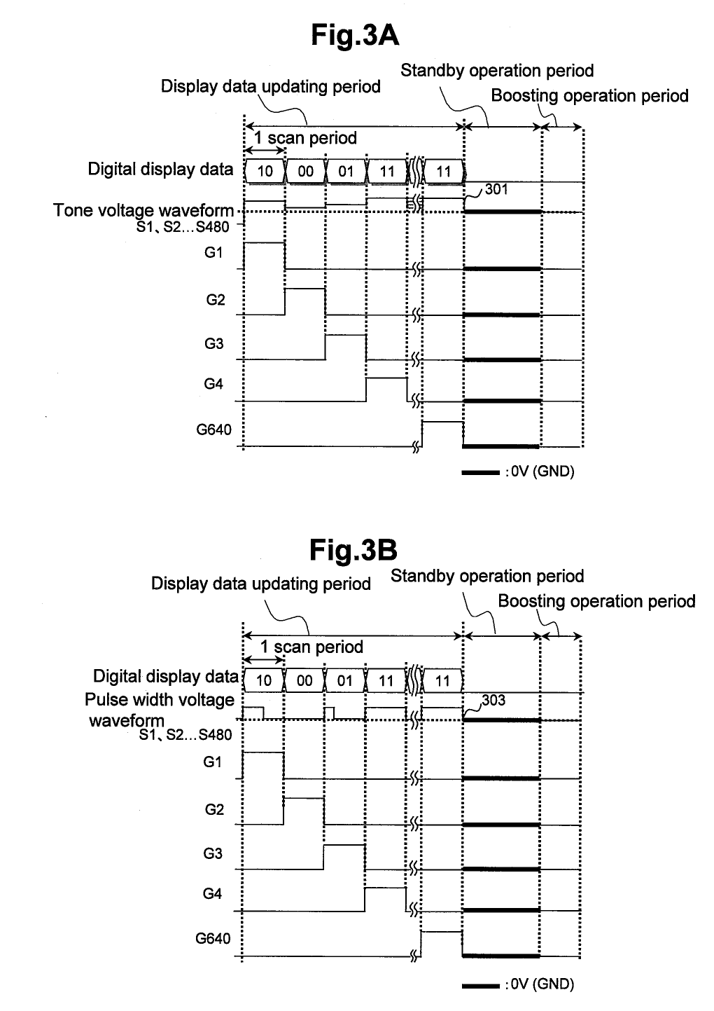

In a concrete embodiment, a plurality of output terminals (S1, S2, . . . , and S480 and G1, G2, . . . , and G640) of the display driver/controller (102) for executing the writing of the display data to the electronic paper display panel (101) are maintained at a ground voltage (GND) level during the standby operation period (refer to FIGS. 3A and 3B).

In the concrete embodiment, the plural output terminals (S1, S2, . . . , and S480 and G1, G2, . . . , and G640) of the display driver/controller (102) are maintained at the ground voltage (GND) level during the standby operation period, undesired influence of display of the display panel of the electronic paper display due to residual charges in the standby operation period can be lessened.

An electronic paper display as a most concrete embodiment is characterized by further including a radio interface (105) for receiving the display data and a request of the writing transferred by radio communication from the host device (refer to FIG. 1).

[2] A typical embodiment of another aspect of the present invention relates to a semiconductor integrated circuit for use in an electronic paper display. The electronic paper display has an electronic paper display panel (101), display driver/controllers (401 and 501), a battery (Bat), and booster power source circuits (402 and 503).

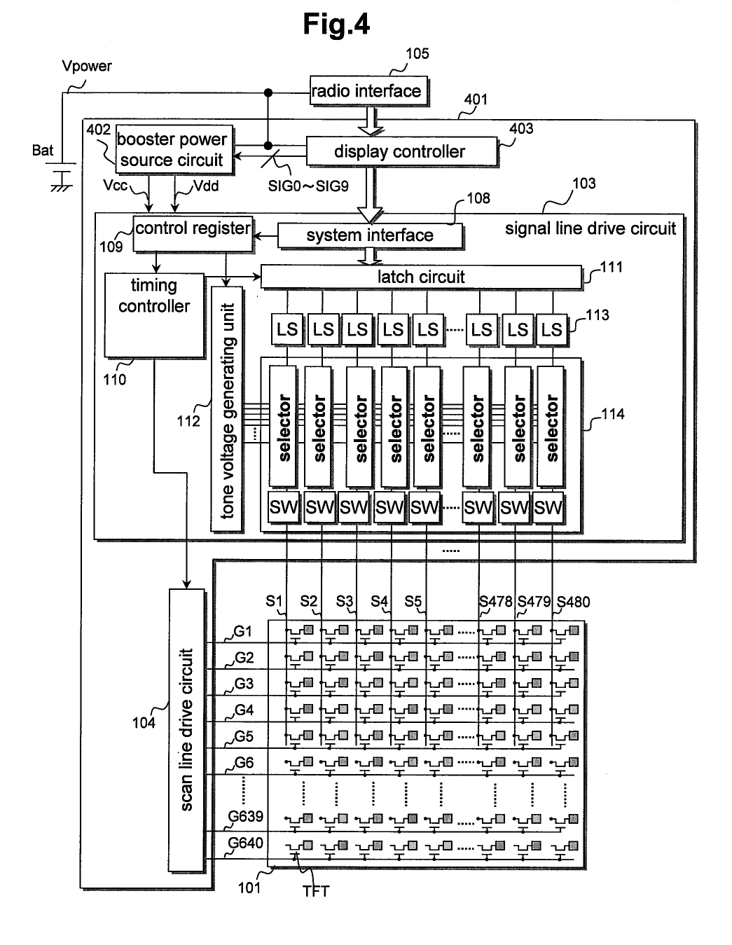

The electronic paper display panel (101) can display data by writing display data and can hold the display even in a no-power state after the writing (refer to FIGS. 4 and 5).

The booster power source circuit (402, 503) generates a boosted power source voltage (Vdd) by an operation of boosting power source voltage (Vpower) supplied from the battery (Bat) (refer to a period from T₁ to T₂ and a period from T₂ to T₃ in FIG. 2B).

The semiconductor integrated circuit has therein at least the display driver/controller (401, 501) and the booster power source circuit (402, 503).

The display driver/controller (401, 501) provided in the semiconductor integrated circuit executes the writing of the displayed data to the electronic paper display panel (101) by using the boosted power source voltage (Vdd) supplied from the booster power source circuit (402, 503) (refer to FIG. 1 and a period from T₂ to T₃ in FIG. 2B).

In a standby operation period in which the electronic paper display panel (101) holds the display in the no-power state after the writing of the display data to the electronic paper display panel (101) performed by the display driver/controller (401, 501), the boosting operation of the booster power source circuit (402, 503) provided in the semiconductor integrated circuit is stopped (refer to FIG. 1 and a period from T₃ to T₄ in FIG. 2B).

In the embodiment, the boosting operation of the booster power source circuit is stopped in a standby operation period in which the electronic paper display panel holds the display in the no-power state after the writing of the display data, so that power consumption in the standby operation period as a period of holding display in the no-power state can be reduced.

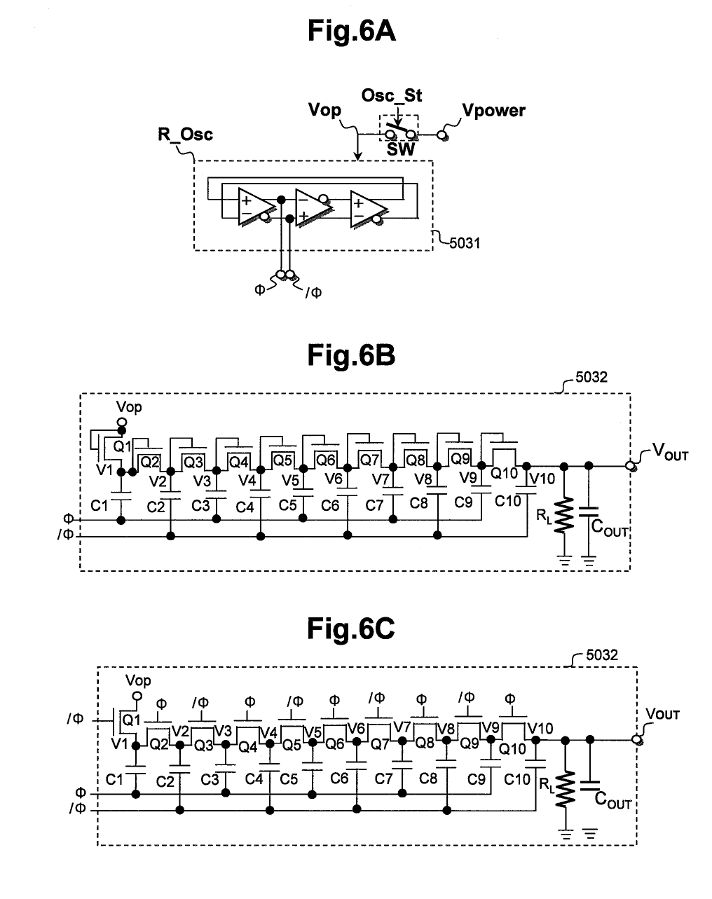

In a preferred embodiment, the booster power source circuit (503) is comprised of charge pump circuits in a plurality of stages including a plurality of switches (Q1 to Q10) and a plurality of capacitors (C1 to C10) (refer to FIGS. 6B and 6C).

A semiconductor integrated circuit as a more preferred embodiment further includes a latch circuit (111), wherein the latch circuit stores digital display data supplied from the host device after the boosting operation of the booster power source circuit (402, 503) starts in response to a request of the writing of the display data to the electronic paper display panel (101) from a host device and the boosted power source voltage (Vdd) reaches a predetermined level at which the writing can be performed (refer to FIGS. 4 and 5).

In the more preferred embodiment, after the boosted power source voltage (Vdd) reaches a predetermined level at which the writing can be performed, the latch circuit (111) stores the digital display data supplied from the host device. Therefore, the number of unnecessary transfer times of the digital display data from the host device can be reduced.

A semiconductor integrated circuit as a further more preferred embodiment further includes a built-in memory (115) for temporarily storing the digital display data supplied from the host device before the digital display data is stored in the latch circuit (111) (refer to FIG. 5).

In the further more preferred embodiment, even when a request for updating display data of the display panel and update display data are transferred almost the same time from the host device, extinction of update display data during boosting operation delay time can be avoided by temporal storage in the built-in memory (115). Consequently, re-transfer of the update display data by the host device can be made unnecessary.

In a concrete embodiment, a plurality of output terminals (S1, S2, . . . , and S480 and G1, G2, . . . , and G640) of the display driver/controller (102) which performs writing of the display data to the electronic paper display panel (101) are maintained at a ground voltage (GND) level during the standby operation period (refer to FIGS. 3A and 3B).

In the concrete preferred embodiment, the plural output terminals (S1, S2, . . . , and S480 and G1, G2, . . . , and G640) of the display driver/controller (102) are maintained at the ground voltage (GND) level during the standby operation period. Consequently, undesired influence on the display of the display panel of the electronic paper display due to residual charges in the standby operation period can be lessened.

A semiconductor integrated circuit as a most concrete embodiment further includes a radio interface (502) for receiving the display data and a request of the writing transferred by radio communication from the host device (refer to FIG. 5).

[3] A typical embodiment of further another aspect of the present invention relates to an operating method for a semiconductor integrated circuit for use in an electronic paper display. The electronic paper display includes an electronic paper display panel (101), a display driver/controller (401, 501), a battery (Bat), and a booster power source circuit (402, 503).

The electronic paper display panel (101) can display data by writing display data and can hold the display even in a no-power state after the writing (refer to FIGS. 4 and 5).

The booster power source circuit (402, 503) generates a boosted power source voltage (Vdd) by an operation of boosting power source voltage (Vpower) supplied from the battery (Bat) (refer to a period from T₁ to T₂ and a period from T₂ to T₃ in FIG. 2B).

The semiconductor integrated circuit has therein at least the display driver/controller (401, 501) and the booster power source circuit (402, 503).

The display driver/controller (401, 501) provided in the semiconductor integrated circuit executes the writing of the display data to the electronic paper display panel (101) by using the boosted power source voltage (Vdd) supplied from the booster power source circuit (402, 503) (refer to FIG. 1 and a period from T₂ to T₃ in FIG. 2B).

In a standby operation period in which the electronic paper display panel (101) holds the display in the no-power state after the writing of the display data to the electronic paper display panel (101) performed by the display driver/controller (401, 501), the boosting operation of the booster power source circuit (402, 503) provided in the semiconductor integrated circuit is stopped (refer to FIG. 1 and a period from T₃ to T₄ in FIG. 2B).

### Explanation of Embodiments

Next, embodiments will be described more specifically. In all of the drawings for explaining best modes for carrying out the invention, the same reference numerals are designated to parts having the same functions as those in the drawings described above, and their description will not be repeated.

### <<Driver/Controller LSI for Controlling Electronic Paper Display>>

FIG. 1 is a diagram showing the configuration of an electronic paper display for use in an electronic tag as an embodiment of the present invention.

An electronic paper display shown in FIG. 1 includes an electronic paper display panel 101, an electronic paper display driver/controller LSI 102, a display controller 107, a boosted power source circuit 106, a radio interface 105, and a battery Bat. The battery Bat used in the embodiment is a battery having a small current capacity called a button battery or coin battery. LSI stands for Large Scale Integrated circuit and denotes a large scale semiconductor integrated circuit.

The radio interface 105 receives control data and display data transferred by radio communication from an external device as a host device and transfers the display data of the electronic tag to the display controller 107.

The booster power source circuit 106 is a booster circuit block for generating voltage level of boosted power source voltage Vdd of about 40 volts necessary for writing display data by a source signal line drive circuit 103 in the electronic paper display driver/controller LSI 102 and a gate scan line drive circuit 104 from power source voltage Vpower of about two volts supplied from the battery Bat. That is, generation of the boosted power source voltage Vdd by boosting about two volts by 20 times to about 40 volts in the booster power source circuit 106 is realized by boosting of “n” times (20 times) of the power source voltage Vpower supplied from the battery Bat by using charge pump circuits cascaded in 20 stages. As will be described in detail, when boosting control signals SIG0 to SIG9 are supplied from the display controller 107 to the booster power source circuit 106, the booster power source circuit 106 is switched in three operation periods of a standby operation period, a boosting operation period, and a display data updating operation period.

The electronic paper display panel 101 is a display capable of holding display even in a no-power state, for example, an electronic paper of an electrophoretic type. The electronic paper has a structure of sandwiching a number of microcapsules in which black particles which are positively charged, white particles which are negatively charged, and viscous liquid are sealed by two transparent sheets or transparent glasses. One of the transparent sheets or transparent glasses is a plane electrode called an opposed electrode. On the other transparent sheet or transparent glass, a plurality of pixel electrodes and a plurality of thin film transistors (TFTs) corresponding to the pixel electrodes are disposed. Source signal lines and gate scan lines coupled to the plural TFTs are arranged in a matrix, thereby configuring the electrode paper display panel 101 of the active matrix type. TFT stands for Thin Film Transistor.

The electronic paper display driver/controller LSI 102 includes the source signal line drive circuit 103 and the gate scan line drive circuit 104. The source signal line drive circuit 103 includes a system interface 108, a control register 109, a timing controller 110, a latch circuit 111, a tone voltage generating unit 112, a level shifter 113, and a tone voltage selector 114.

The source signal line drive circuit 103 in the electronic paper display driver/controller LSI 102 converts the digital display data transferred from the display controller 107 to analog tone voltage. The analog tone voltage is applied to pixel electrodes coupled to the source terminals of the TFTs via the source signal lines S1, S2, . . . , and S480 in the electronic paper display panel 101. That is, the black and white particles in the microcapsules move according to the tone voltage level applied to the pixel electrodes, thereby controlling display of the electronic paper display panel 101. Concretely, in the case where a voltage higher than the voltage applied to the opposed electrode as a reference is applied to the pixel electrodes, the white particles negatively charged gather on the pixel electrode side, so that display on the electronic paper display panel 101 has high brightness. In the case where a voltage lower than the voltage of the opposed electrode as a reference is applied to the pixel electrodes, the black particles positively charged gather on the pixel electrode side, so that display on the electronic paper display panel 101 has low brightness.

The gate scan line drive circuit 104 sequentially applies scan pulse voltage for turning on the TFTs to the gate scan lines G1, G2, . . . , and G640 in the electronic paper display panel 101.

The display controller 107 converts the control data and the display data supplied from the radio interface 105 to a data format conformed with the interface specification of the source signal line drive circuit 103 and transmits the converted data to the source signal line drive circuit 103. The display controller 107 generates the control signals SIG0 to SIG9 for switching the operation period of the booster power source circuit 106 and supplies them to the booster power source circuit 106.

Next, the operation of each of the blocks configuring the source signal line drive circuit 103 will be described.

The system interface 108 performs an operation of receiving display data and an instruction from the display controller 107 and outputting them to the control register 109. The instruction is control information for controlling the operations of the source signal line drive circuit 103 and the gate scan line drive circuit 104, and includes various setting parameters such as setting of the number of drive lines of the source signal lines and the gate scan lines and setting of timings of supplying/interrupting boosted voltage.

The control register 109 has therein the latch circuit and transfers a display timing setting of the electronic paper display panel 101 transferred from the system interface 107 to the timing controller 110. Specifically, the display timing of the electronic paper display panel 101 corresponds to boosting operation delay time since the booster power source circuit 106 starts the boosting operation in response to the request for updating display data of the electronic paper display panel 101 supplied from an external device as a host device via the radio interface 105 until the boosted power source voltage Vdd reaches a predetermined level. After the display timing at which the boosted power source voltage Vdd reaches the predetermined level, in response to the control of the timing controller 109, the latch circuit 111 stores digital display data supplied from an external device as a host device via the radio interface 105, the display controller 107, and the system interface 108.

In another embodiment of the present invention, the display timing at which the boosted power source voltage Vdd reaches the predetermined level is transferred from any of the electronic paper display driver/controller LSI 102, the booster power source circuit 106, and the display controller 107 to the external device as a host device via the radio interface 105. Therefore, from the transferred display timing, the host device determines that the boosted power source voltage Vdd of the booster power source circuit 106 reaches the predetermined level and writing of update display data of the electronic paper display panel 101 by the electronic paper display driver/controller LSI 102 becomes possible. As a result, in response to the display timing, the host device transfers the update display data of the electronic paper display panel 101 to the electronic paper display driver/controller LSI 102 via the radio interface 105 and the display controller 107. The update display data transferred is sequentially stored in the latch circuit 111 every horizontal line and is written in the entire electronic paper display panel 101.

On the other hand, the timing controller 110 has a dot counter. The dot counter counts display dot clocks, thereby generating a clock signal such as a horizontal sync clock signal Hsync. The timing controller 110 generates a control signal for controlling the operation of the source signal line drive circuit 103 and the gate scan line drive circuit 104 in response to a control timing supplied from the control register 109.

The latch circuit 111 operates at a trailing timing of a line clock supplied from the timing controller 110 and outputs digital display data of the amount of one horizontal line in parallel to a plurality of tone voltage selectors 114.

The tone voltage generating unit 112 is a circuit for generating tone voltages of N levels for determining display brightness of the electronic paper display panel 101. For example, the tone voltage generating unit 112 includes a plurality of ladder resistors coupled in series between the boosted power source voltage Vdd of about 40 volts from the booster power source circuit 106 and the ground voltage GND and supplies, in parallel, tone voltages of N levels generated at a voltage dividing ratio of the ladder resistors to the plural tone voltage selectors 114. For example, in the case of gray scale display in which the number of display colors of the source signal line drive circuit 103 is four colors (2 bits), N=4. In the case of monochromatic display using one display color (1 bit), N=2.

The plural level shifters 113 converts the amplitude of digital display data supplied from the latch circuit 111 from low amplitude between the low power source voltage Vcc and the ground voltage GND to high amplitude between the high power source voltage Vdd and the ground voltage GND, and supplies the high-amplitude digital display data to the tone voltage selector 114.

The tone voltage selector 114 selects one analog tone voltage from the analog tone voltages of N levels supplied from the tone voltage generating unit 112 in response to the high-amplitude digital display data supplied from the level shifter 113. The plural tone voltage selectors 114 execute D/A (Digital/Analog) conversion of converting the high-amplitude digital display data to one analog tone voltage. Between output parts of the plural tone voltage selectors 114 and the source signal lines S1, S2, . . . , and S480 of the electronic paper display panel 101, a plurality of switches SW are coupled. The plural switches SW are controlled to the off state at the interruption timing, thereby controlling outputs of the plural tone voltage selectors 114 to a high-impedance (Hi-Z) state.

At a timing when a plurality of analog tone voltages are prepared at the plural output terminals of the tone voltage selector 114, the gate scan line drive circuit 104 applies the high-level scan pulse voltage to the first gate scan line G1 in the gate scan lines G1, G2, . . . , and G640 of the electronic paper display panel 101. By the application, the plural thin film transistors (TFT) coupled to the first gate scan line G1 are turned on, so that update display data of the amount of one horizontal line is written in the plural pixels coupled to the first gate scan line G1 in the electronic paper display panel 101. Similarly, at sequential timings when the analog tone voltages are prepared at the plural output terminals of the tone voltage selector 114, the gate scan line drive circuit 104 sequentially applies the high-level scan pulse voltage to the other gate scan line G2 to G640 of the electronic paper display panel 101, thereby writing the update display data to the entire electronic paper display panel 101.

As described above, the control register 109 and the timing controller 110 control the timings of storing display data to the latch circuit 111 and writing update display data of the electronic paper display panel 101 by the source signal line drive circuit 103 and the gate scan line drive circuit 104 in consideration of the boosting operation delay time of the booster power source circuit 106 in response to the display data update request of the electronic paper display panel 101 from an external device as the host device.

In a standby operation period in which the electronic paper display panel 101 holds the display in the no-power state after the writing of the display data, the plural output terminals S1, S2, . . . , and S480 and G1, G2, . . . , and G640 of the source signal line drive circuit 103 and the gate scan line drive circuit 104 in the display driver/controller LSI 102 coupled to the electronic paper display panel 101 are controlled to the level of the ground voltage GND. Therefore, in the standby operation period in which the electronic paper display panel 101 holds the display in the no-power state, residual charges of high voltage of the display panel 101 from the booster power source circuit 106 are discharged to the plural output terminals S1, S2, . . . , and S480 and G1, G2, . . . , and G640 which are controlled at the ground voltage GND. Therefore, undesired influence on the electronic paper display panel 101 of the residual charges can be lessened.

### <<Booster Power Source Circuit>>

FIGS. 2A and 2B are diagrams illustrating the configuration and operation of the booster power source circuit 106 for supplying the boosted power source voltage Vdd to the electronic paper display driver/controller LSI 102 in the embodiment of the invention shown in FIG. 1.

FIG. 2A shows a block configuration in the booster power source circuit 106. The booster power source circuit 106 is comprised of charge pump circuits in a plurality of stages including a plurality of switches 201 to 210 and a plurality of capacitors 211 and 212. As described above, the booster power source circuit 106 is a booster circuit block for generating voltage level of boosted power source voltage Vdd of about 40 volts necessary for writing display data by the electronic paper display driver/controller LSI 102 from power source voltage Vpower of about 2 volts supplied from the battery Bat. By the control of on/off operation of the plural switches 201 to 210, desired boosted high power source voltage Vdd and boosted low power source voltage Vcc are generated.

In FIG. 2A, double boosting as the simplest configuration is shown to make the explanation easier. In practice, boosting of about 20 times is executed so that the boosted power source voltage level requested by the electronic paper display driver/controller LSI 102 is obtained.

In particular, in the embodiment of the present invention, in the display data updating operation period for writing display data in the electronic paper display panel 101, the boosted high power source voltage Vdd is output to an analog circuit power source output terminal Vout1, and the boosted low power source voltage Vcc is generated at the logic circuit power source output terminal Vout2. In the embodiment of the invention, in addition to the display data updating operation period, a boosting operation period and a standby operation period for executing charging of the plural capacitors 211 and 212 are provided. The three operation periods can be realized by a change in the waveforms of the boosting control signals SIG0 to SIG9 supplied from the display controller 107 to the booster power source circuit 106.

FIG. 2B is a timing chart showing the on/off operation of the plural switches 201 to 210 of the booster power source circuit 106. Particularly, FIG. 2B shows the relation of levels of the plural control signals SIG0 to SIG9 supplied to the plural switches 201 to 210 in the standby operation period, the boosting operation period, and the display data updating operation period as a characteristic of the embodiment of the present invention.

The standby operation period from time T₀ time T₁ and the standby operation period from time T₃ to time T₄ are time in which display of the electronic paper display panel 101 does not change. By the supply of the control signals SIG0 to SIG9 of the fixed level from the display controller 107, the switches 202, 208, 209, and 210 are controlled in the on state, and the other switch 201 and the switches 203 to 206 are controlled in the off state. In such a manner, the analog circuit power source output terminal Vout1 and the logic circuit power source output terminal Vout2 are stably maintained at the voltage level of the ground voltage GND.

The boosting operation period from the time T₁ to time T₂ is time in which the boosting operation for updating display of the electronic paper display panel 101 is executed. By the supply of the control signals SIG0 to SIG9 from the display controller 107, the switch 201, the switches 203 to 206, and the switch 210 are controlled in the on state, and the other switches 202, 208, and 209 are controlled in the off state. As a result, the plural capacitors 211 and 212 are charged in parallel by the power source voltage Vpower of about two volts supplied from the battery Bat. During the period, the analog circuit power source output terminal Vout1 and the logic circuit power source output terminal Vout2 are electrically isolated from the plural switches 201 to 210 and the plural capacitors 211 and 212 of the booster power source circuit 106 by the switches 208 and 209.

The display data updating operation period from the time T₂ to time T₃ is time in which display in the electronic paper display panel 101 is updated. By the supply of the control signals SIG0 to SIG9 from the display controller 107, the switch 203 and the switches 205 to 209 are controlled in the on state, and the other switches 201, 202, 204, and 210 are controlled in the off state. Therefore, since the plural capacitors 211 and 212 charged by the power source voltage Vpower are coupled in series between the analog circuit power source output terminal Vout1 and the ground voltage GND, the boosted high power source voltage Vdd (=Vpower×2) which is double is generated from the analog circuit power source output terminal Vout1, and boosted low power source voltage Vcc (=Vpower×1) which is not multiplied is generated from the logic circuit power source output terminal Vout2.

### <<Display Data Writing Operation>>

FIGS. 3A and 3B are diagrams illustrating operation of writing update display data of the electronic paper display panel 101 by the source signal line drive circuit 103 and the gate scan line drive circuit 104 of the electronic paper display driver/controller LSI 102 in the embodiment of the present invention shown in FIG. 1.

FIG. 3A is an operation waveform diagram of the case of controlling display brightness of the electronic paper display panel 101 in response to the tone voltage level. In each of horizontal line scan periods in the display data updating period, digital display data of the amount of one horizontal line from the latch circuit 111 of the source signal line driver circuit 103 is converted to tone voltages 301 of the analog voltage levels S1, S2, . . . , and S480 of one horizontal line by the plural level shifters 113 and the plural tone voltage selectors 114. In a plurality of horizontal line scan periods in the display data updating period, the gate scan line drive circuit 104 sequentially applies high-level scan pulse voltage to the gate scan lines G1, G2, . . . , and G640 of the electronic paper display panel 101, thereby writing update display data to the entire electronic paper display panel 101. In the standby operation period, the plural switches SW of the tone voltage selectors 114 are controlled to the off state and outputs of the tone voltage selectors 114 of the source signal line drive circuit 103 are controlled to a zero-volt state (state of the ground potential GND). On the other hand, the output of the gate scan line drive circuit 104 is also controlled to the zero-volt state (state of the ground potential GND).

FIG. 3B is an operation waveform diagram showing the case of controlling display brightness of the electronic paper display panel 101 in response to the pulse width of the pulse voltage. In each of horizontal line scan periods in the display data updating period, digital display data of the amount of one horizontal line from the latch circuit 111 of the source signal line driver circuit 103 is converted to pulse width of the pulse voltages S1, S2, . . . , and S480. In a plurality of horizontal line scan periods in the display data updating period, the gate scan line drive circuit 104 sequentially applies high-level scan pulse voltage to the gate scan lines G1, G2, . . . , and G640 of the electronic paper display panel 101, thereby writing update display data to the entire electronic paper display panel 101. In the standby operation period, the plural switches SW of the tone voltage selectors 114 are controlled to the off state and outputs of the tone voltage selectors 114 of the source signal line drive circuit 103 are controlled to a zero-volt state (state of the ground potential GND). On the other hand, the output of the gate scan line drive circuit 104 is also controlled to the zero-volt state (state of the ground potential GND).

### <<Driver/Controller LSI of Another Embodiment>>

FIG. 4 is a diagram showing the configuration of the electronic paper display driver/controller LSI 102 as another embodiment of the present invention.

An electronic paper display driver/controller LSI 401 shown in FIG. 4 has therein a booster power source circuit 402 having the function equivalent to that of the booster power source circuit 106 of the electronic paper display illustrated in FIG. 1, and a display controller 403 having the function equivalent to that of the display controller 107.

The function of the electronic paper display driver/controller LSI 401 shown in FIG. 4 is the same as that of the electronic paper display driver/controller LSI 102, the booster power source circuit 106, and the display controller 107 in the electronic paper display shown in FIG. 1.

FIG. 5 is a diagram showing the configuration of an electronic paper display driver/controller LSI 501 as further another embodiment of the present invention.

An electronic paper display driver/controller LSI 501 shown in FIG. 5 has therein a radio interface 502 having the function equivalent to that of the radio interface 105 of the electronic paper display illustrated in FIG. 1. The electronic paper display driver/controller LSI 501 shown in FIG. 5 has therein a booster power source circuit 503 having the function equivalent to that of the booster power source circuit 106 of the electronic paper display shown in FIG. 1, and a display controller 504 having the function equivalent to that of the display controller 107.

The source signal line drive circuit 103 of the electronic paper display driver/controller LSI 501 shown in FIG. 5 has therein a graphic RAM 115 coupled between the system interface 108 and the latch circuit 111. Therefore, the electronic paper display driver/controller LSI 501 shown in FIG. 5 receives a request for updating display data of the electronic paper display panel 101 supplied from an external device as the host device via the radio interface 105 and digital display data accompanying the update, and can temporarily store the received digital display data into the graphic RAM 115. At this time, by setting the storage capacity of the digital display data temporarily stored in the graphic RAM 115 to at least the update display data of the entire electronic paper display panel 101, the number of transfer times of digital display data from the host device can be reduced.

In the electronic paper display driver/controller LSI 501 shown in FIG. 5, in response to a request for updating display data of the electronic paper display panel 101 supplied from the external device as the host device via the radio interface 105, the booster power source circuit 503 starts the boosting operation. The boosting operation delay time until the boosted power source voltage Vdd reaches a predetermined level after start of the boosting operation is counted by a not-shown counter circuit. After lapse of the boosting operation delay time, a count output signal of the counter circuit changes from the low level to the high level. In response to a change in the level of the count output signal of the counter circuit, digital display data stored in the graphic RAM 115 is read. The digital display data read from the graphic RAM 115 is sequentially supplied to the latch circuit 111 every horizontal line, and the update display data can be written in the entire electronic paper display panel 101.

### <<Configuration of Built-In Booster Power Source Circuit>>

FIGS. 6A, 6B, and 6C are diagrams showing the configuration of the booster power source circuit 503 provided in the electronic paper display driver/controller LSI 501 illustrated in FIG. 5.

FIG. 6A shows a ring oscillator R_Osc for generating complementary clock signals Φ and /Φ for driving the booster power source circuit 503. The ring oscillator R_Osc includes, for example, a differential delay circuit 5031 in odd-numbered stages such as three stages. The power source switch SW is turned on by an oscillation start signal OSc_St generated in response to the request for updating display data of the electronic paper display panel 101 from the external device as the host device, and the power source voltage Vpower from the battery Bat is supplied as an operation voltage Vop to the differential delay circuit 5031 of the ring oscillator R_Osc.

FIG. 6B shows a configuration of a booster power source voltage generating circuit 5032 of the booster power source circuit 503 driven by the complementary clock signals Φ and /Φ generated by the differential delay circuit 5031 of the ring oscillator R_Osc shown in FIG. 6A. The booster power source voltage generating circuit 5032 includes first-stage to tenth-stage charge pumps.

The booster power source voltage generating circuit 5032 includes a first-stage charge pump including a first MOS transistor Q1 which is diode-coupled and a first capacitor C1 between the operation voltage Vop and the non-inversion complementary clock signal Φ. It includes a second-stage charge pump including a second MOS transistor Q2 which is diode-coupled and a second capacitor C2 between the output voltage V1 of the first-stage charge pump and the inversion complementary clock signal /Φ. It includes a third-stage charge pump including a third MOS transistor Q3 which is diode-coupled and a third capacitor C3 between the output voltage V2 of the second-stage charge pump and the non-inversion complementary clock signal Φ.

In a similar manner, it includes a tenth-stage charge pump including a tenth MOS transistor Q10 which is diode-coupled and a tenth capacitor C10 between the output voltage V9 of the ninth-stage charge pump and the inversion complementary clock signal /Φ. By coupling a smoothing resistor R_{L} and a smoothing capacitor C_{OUT} which are coupled in parallel to an output terminal of the tenth-stage charge pump at the final stage, output voltage V_{OUT} of the boosted voltage level of ten times is generated. The booster power source circuit 503 in the electronic paper display driver/controller LSI 501 shown in FIG. 5 has a configuration which is twice of that of the booster power source voltage generating circuit 5032 shown in FIG. 6B.

FIG. 6C shows another configuration of the booster power source voltage generating circuit 5032 of the booster power source circuit 503 driven by the complementary clock signals Φ and /Φ generated by the differential delay circuit 5031 of the ring oscillator R_Osc shown in FIG. 6A. Similarly, the booster power source voltage generating circuit 5032 includes first-stage to tenth-stage charge pumps.

The booster power source voltage generating circuit 5032 shown in FIG. 6C includes a first-stage charge pump including a first MOS transistor Q1 whose gate is driven by the inversion complementary clock signal /Φ and a first capacitor C1 between the operation voltage Vop and the non-inversion complementary clock signal Φ. It includes a second-stage charge pump including a second MOS transistor Q2 whose gate is driven by the inversion complementary clock signal /Φ and a second capacitor C2 between the output voltage V1 of the first-stage charge pump and the inversion complementary clock signal /Φ. It includes a third-stage charge pump including a third MOS transistor Q3 whose gate is driven by the inversion complementary clock signal /Φ and a third capacitor C3 between the output voltage V2 of the second-stage charge pump and the non-inversion complementary clock signal Φ.

In a similar manner, it includes a tenth-stage charge pump including a tenth MOS transistor Q10 whose gate is driven by the inversion complementary clock signal /Φ and a tenth capacitor C10 between the output voltage V9 of the ninth-stage charge pump and the inversion complementary clock signal /Φ. By coupling a smoothing resistor R_{L} and a smoothing capacitor C_{OUT} which are coupled in parallel, to an output terminal of the tenth-stage charge pump at the final stage, output voltage V_{OUT} of the boosted voltage level of ten times is generated. The booster power source circuit 503 in the electronic paper display driver/controller LSI 501 shown in FIG. 5 has a configuration which is twice of that of the booster power source voltage generating circuit 5032 shown in FIG. 6C.

### <<Boosting Operation of Built-In Booster Power Source Circuit>>

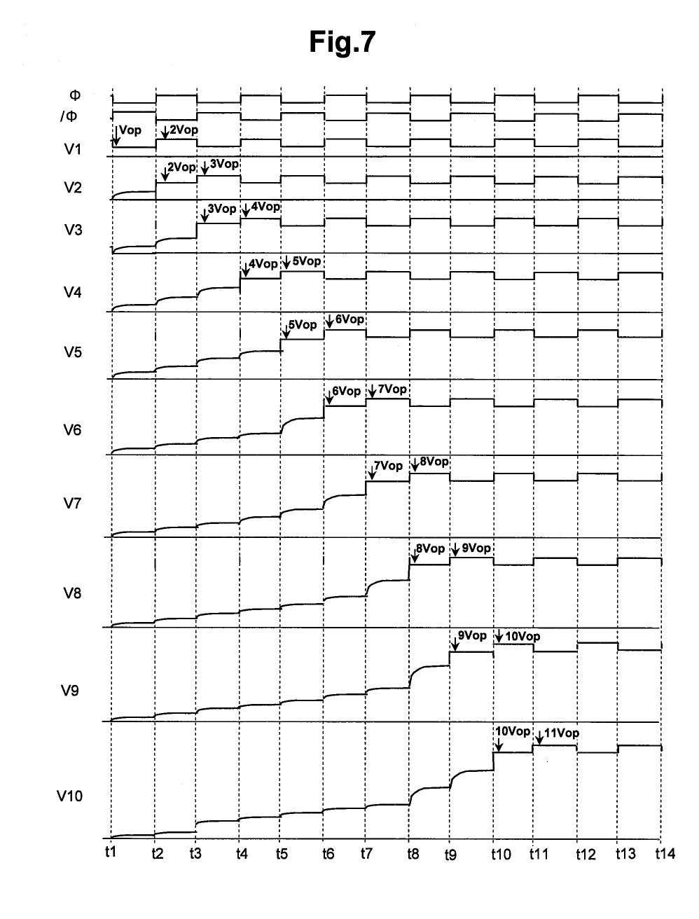

FIG. 7 is a diagram illustrating boosted voltage generating operation executed by the booster power source voltage generating circuit 5032 shown in FIG. 6B.

As shown in FIG. 7, in a first period from the time t₁ to the time t₂, the non-inversion complementary clock signal Φ is set to the level of the ground voltage, and the inversion complementary clock signal /Φ is set to the level of the operation voltage Vop, so that the output voltage V1 of the first-stage charge pump is charged to the voltage level which is the same as that of the operation voltage Vop.

In a second period from the time t₂ to the time t₃, the non-inversion complementary clock signal Φ is set to the level of the operation voltage Vop, and the inversion complementary clock signal /Φ is set to the level of the ground voltage, so that the output voltage V1 of the first-stage charge pump and the output voltage V2 of the second-stage charge pump are charged to the voltage level which is twice as high as that of the operation voltage Vop.

In a third period from the time t₃ to the time t₄, the non-inversion complementary clock signal Φ is set to the level of the ground voltage, and the inversion complementary clock signal /Φ is set to the level of the operation voltage Vop, so that the output voltage V2 of the second-stage charge pump and the output voltage V3 of the third-stage charge pump are charged to the voltage level which is three times as high as that of the operation voltage Vop.

In a similar manner, in a tenth period from the time t₁₀ to the time t₁₁, the non-inversion complementary clock signal Φ is set to the level of the operation voltage Vop, and the inversion complementary clock signal /Φ is set to the level of the ground voltage, so that the output voltage V9 of the ninth-stage charge pump and the output voltage V10 of the tenth-stage charge pump are charged to the voltage level which is ten times as high as that of the operation voltage Vop.

As described above, in response to the output voltage V_{OUT} having a voltage level which is ten times as high as that of the operation voltage Vop at and after the time t₁₀ shown in FIG. 7, the digital display data of the amount of one horizontal line is sequentially read from the graphic RAM 115 to the latch circuit 111, and update display data can be written in the entire electronic paper display panel 101.

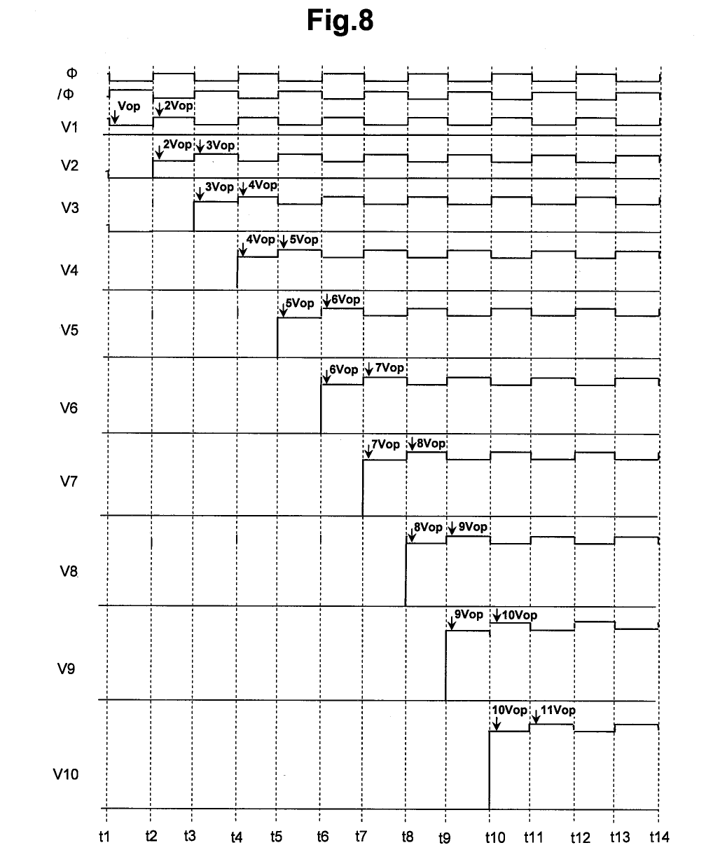

FIG. 8 is a diagram illustrating boosted voltage generating operation executed by the booster power source voltage generating circuit 5032 shown in FIG. 6C.

As shown in FIG. 8, in the first period from the time t₁ to the time t₂, the non-inversion complementary clock signal Φ is set to the level of the ground voltage, and the inversion complementary clock signal /Φ is set to the level of the operation voltage Vop, so that the output voltage V1 of the first-stage charge pump is charged to the voltage level which is the same as that of the operation voltage Vop.

In a second period from the time t₂ to the time t₃, the non-inversion complementary clock signal Φ is set to the level of the operation voltage Vop, and the inversion complementary clock signal /Φ is set to the level of the ground voltage, so that the output voltage V1 of the first-stage charge pump and the output voltage V2 of the second-stage charge pump are charged to the voltage level which is twice as high as that of the operation voltage Vop.

In a third period from the time t₃ to the time t₄, the non-inversion complementary clock signal Φ is set to the level of the ground voltage, and the inversion complementary clock signal /Φ is set to the level of the operation voltage Vop, so that the output voltage V2 of the second-stage charge pump and the output voltage V3 of the third-stage charge pump are charged to the voltage level which is three times as high as that of the operation voltage Vop.

In a similar manner, in a tenth period from the time t₁₀ to the time t₁₁, the non-inversion complementary clock signal Φ is set to the level of the operation voltage Vop, and the inversion complementary clock signal /Φ is set to the level of the ground voltage, so that the output voltage V9 of the ninth-stage charge pump and the output voltage V10 of the tenth-stage charge pump are charged to the voltage level which is ten times as high as that of the operation voltage Vop.

As described above, in response to the output voltage V_{OUT} having a voltage level which is ten times as high as that of the operation voltage Vop at and after the time t₁₀ shown in FIG. 8, the digital display data of the amount of one horizontal line is sequentially read from the graphic RAM 115 to the latch circuit 111, and update display data can be written in the entire electronic paper display panel 101.

The present invention achieved by the inventors herein has been described concretely on the basis of the embodiments. The present invention, however, is not limited to the embodiments but obviously can be variously changed without departing from the gist.

For example, the electronic paper display panel of the electrophoretic type has been described as an example of the electronic paper display panel 101. The present invention can be also applied to any of electronic paper display panels of the other types such as an electronic particulate material type, a cholesteric liquid crystal type, or the like as long as it has a display holding characteristic in the no-power state. Although the present invention has been described on the precondition of using the display panel of the active matrix type, the present invention can be also applied to a display panel of a passive matrix type in which a thin film transistor (TFT) is not disposed for each of the pixels and the electronic paper display panel 101 having the display holding characteristic in the no-power state.

Although the characteristic of the present invention has been described only by three kinds of the display data updating period, the standby operation period, and the boosting operation period, the present invention can be also applied to a type of the electronic paper display panel in which display of the display panel has to be erased by application of high voltage at once in an erasing operation period before updating of display data.

1. An electronic paper display comprising an electronic paper display panel, a display driver/controller, a battery, and a booster power source circuit,
wherein the electronic paper display panel can display data by writing display data and can hold the display even in a no-power state after the writing,
wherein the booster power source circuit generates a boosted power source voltage by an operation of boosting power source voltage supplied from the battery,
wherein the display driver/controller executes the writing of the displayed data to the electronic paper display panel by using the boosted power source voltage supplied from the booster power source circuit, and
wherein in a standby operation period in which the electronic paper display panel holds the display in the no-power state after the writing of the display data to the electronic paper display panel performed by the display driver/controller, the boosting operation of the booster power source circuit is stopped.

2. The electronic paper display according to claim 1, wherein the booster power source circuit is comprised of charge pump circuits in a plurality of stages including a plurality of switches and a plurality of capacitors.

3. The electronic paper display according to claim 1, further comprising a latch circuit,
wherein the latch circuit stores digital display data supplied from the host device after the boosting operation of the booster power source circuit starts in response to a request of the writing of the display data to the electronic paper display panel from a host device and the boosted power source voltage reaches a predetermined level at which the writing can be performed.

4. The electronic paper display according to claim 3, further comprising a built-in memory for temporarily storing the digital display data supplied from the host device before the digital display data is stored in the latch circuit.

5. The electronic paper display according to claim 1, wherein a plurality of output terminals of the display driver/controller for executing the writing of the display data to the electronic paper display panel are maintained at a ground voltage level during the standby operation period.

6. The electronic paper display according to claim 1, further comprising a radio interface for receiving the display data and a request of the writing transferred by radio communication from the host device.

7. A semiconductor integrated circuit for use in an electronic paper display, the electronic paper display comprising an electronic paper display panel, a display driver/controller, a battery, and a booster power source circuit,
wherein the electronic paper display panel can display data by writing display data and can hold the display even in a no-power state after the writing,
wherein the booster power source circuit generates a boosted power source voltage by an operation of boosting power source voltage supplied from the battery,
wherein the semiconductor integrated circuit has therein at least the display driver/controller and the booster power source circuit,
wherein the display driver/controller provided in the semiconductor integrated circuit executes the writing of the displayed data to the electronic paper display panel by using the boosted power source voltage supplied from the booster power source circuit, and
wherein in a standby operation period in which the electronic paper display panel holds the display in the no-power state after the writing of the display data to the electronic paper display panel performed by the display driver/controller, the boosting operation of the booster power source circuit provided in the semiconductor integrated circuit is stopped.

8. The semiconductor integrated circuit according to claim 7, wherein the booster power source circuit is comprised of charge pump circuits in a plurality of stages including a plurality of switches and a plurality of capacitors.

9. The semiconductor integrated circuit according to claim 7, further comprising a latch circuit,
wherein the latch circuit sores digital display data supplied from the host device after the boosting operation of the booster power source circuit starts in response to a request of the writing of the display data to the electronic paper display panel from a host device and the boosted power source voltage reaches a predetermined level at which the writing can be performed.

10. The semiconductor integrated circuit according to claim 9, further comprising a built-in memory for temporarily storing the digital display data supplied from the host device before the digital display data is stored in the latch circuit.

11. The semiconductor integrated circuit according to claim 7, wherein a plurality of output terminals of the display driver/controller for executing the writing of the display data to the electronic paper display panel are maintained at a ground voltage level during the standby operation period.

12. The semiconductor integrated circuit according to claim 7, further comprising a radio interface for receiving the display data and a request of the writing transferred by radio communication from the host device.

13. An operating method for a semiconductor integrated circuit for use in an electronic paper display,
the electronic paper display comprising an electronic paper display panel, a display driver/controller, a battery, and a booster power source circuit,
wherein the electronic paper display panel can display data by writing display data and can hold the display even in a no-power state after the writing,
wherein the booster power source circuit generates a boosted power source voltage by an operation of boosting power source voltage supplied from the battery,
wherein the semiconductor integrated circuit has therein at least the display driver/controller and the booster power source circuit,
wherein the display driver/controller provided in the semiconductor integrated circuit executes the writing of the display data to the electronic paper display panel by using the boosted power source voltage supplied from the booster power source circuit, and
wherein in a standby operation period in which the electronic paper display panel holds the display in the no-power state after the writing of the display data to the electronic paper display panel performed by the display driver/controller, the boosting operation of the booster power source circuit provided in the semiconductor integrated circuit is stopped.

14. The operating method for a semiconductor integrated circuit according to claim 13, wherein the booster power source circuit is comprised of charge pump circuits in a plurality of stages including a plurality of switches and a plurality of capacitors.

15. The operating method for a semiconductor integrated circuit according to claim 13,
wherein the semiconductor integrated circuit further comprises a latch circuit, and
wherein, after the boosting operation of the booster power source circuit starts in response to a request of the writing of the display data to the electronic paper display panel from a host device and the boosted power source voltage reaches a predetermined level at which the writing can be performed, digital display data supplied from the host device is stored in the latch circuit.

16. The operating method for a semiconductor integrated circuit according to claim 15,
wherein the semiconductor integrated circuit further comprises a built-in memory, and
wherein the digital display data supplied from the host device before the digital display data is stored in the latch circuit is temporarily stored in the built-in memory.

17. The operating method for a semiconductor integrated circuit according to claim 13, wherein a plurality of output terminals of the display driver/controller for executing the writing of the display data to the electronic paper display panel are maintained at a ground voltage level during the standby operation period.

18. The operating method for a semiconductor integrated circuit according to claim 13,
wherein the semiconductor integrated circuit further comprises a radio interface, and
wherein the display data and a request of the writing transferred by radio communication from the host device are received by the radio interface.
